(19) United States
(12) Patent Application Publication
(10) Pub. No.: US 2018/0319930 A1
(43) Pub. Date: Nov. 8, 2018

(54) METHOD OF FORMING A CURED EPOXY MATERIAL, CURED EPOXY MATERIAL FORMED THEREBY, PHENYLENE ETHER OLIGOMER-ANHYDRIDE REACTION PRODUCT USEFUL IN THE METHOD, AND COMPOSITE CORE INCORPORATING THE CURED EPOXY MATERIAL

(71) Applicant: SABIC GLOBAL TECHNOLOGIES, B.V., Bergen op Zoom (NL)

(72) Inventors: Edward Norman Peters, Lenox, MA (US); Ying Na, Shanghai (CN); Shuailei Ma, Evansville, IN (US); Jian Yang, Shanghai (CN)

(21) Appl. No.: 15/775,110

(22) PCT Filed: Oct. 12, 2016
(86) PCT No.: PCT/US2016/056519

§ 371 Date: May 10, 2018

Related U.S. Application Data
(60) Provisional application No. 62/256,154, filed on Nov. 17, 2015.

(51) Int. Cl. C08G 59/42; C08G 65/48; H01B 1/02; H01B 17/56

(52) U.S. Cl. CPC C08G 59/4238; C08G 65/485; H01B 17/56; H01B 1/02; C08G 59/4269

(57) ABSTRACT

A method of forming a cured epoxy material includes pre-reacting a phenylene ether oligomer with an anhydride hardener before adding an epoxy resin and a curing promoter, then curing the resulting composition. The method provides an improved balance of heat resistance and toughness relative to corresponding methods in which the phenylene ether oligomer is pre-reacted with the epoxy resin prior to addition of hardener, and in which all components are mixed simultaneously. The cured epoxy material can be used in the composite core of an aluminum conductor composite core reinforced cable.

### BACKGROUND OF THE INVENTION

An important route to increasing the glass transition temperature (T_{g}) in thermoset resins is to increase the crosslink density of the network. High-functionality epoxy resins have been used to increase the crosslink densities and obtain high T_{g} cured materials. Becker has reported that tetra-functional tetraglycidyldiaminodiphenylmethane (TGDDM) and aromatic diamines such as diethyltoluene diamine (DETDA) can produce cured materials with T_{g} values greater than 200° C. O. Becker, R. Varley, G. Simon, Polymer 2002, volume 43, pages 4365-4373.

In general, higher crosslink densities restrict the motion of the molecular chains between crosslink sites. This restricted motion also results in an undesirable decrease in toughness. Hence, there is a tradeoff between high T_{g} and toughness. Hence, a challenge in formulating multi-functional epoxy resins is to obtain high T_{g} materials while maintaining or increasing the toughness.

### BRIEF SUMMARY OF EMBODIMENTS OF THE INVENTION

One embodiment is a method of forming a cured epoxy material, the method comprising: reacting a phenylene ether oligomer with an anhydride hardener to form a first product; adding an epoxy resin to the first product to form a second product; and curing the second product to form a cured epoxy material.

Another embodiment is a cured epoxy material formed by the method of any one of claims 1-17 and exhibiting a glass transition temperature of 150 to 250° C. measured by differential scanning calorimetry, and an unnotched Izod impact strength of 80 to 200 joules/meter at 23° C. determined according to ASTM D 4812-11 at 23° C.

Another embodiment is a product of reacting a phenylene ether oligomer with a monoanhydride, wherein the phenylene ether oligomer has, on average, 1.5 to 3 hydroxyl groups per molecule, wherein the phenylene ether oligomer and the monoanhydride are reacted in amounts effective to provide an initial molar ratio of hydroxyl groups to anhydride groups of 0.04:1 to 0.26:1, and wherein in the product at least 75 mole percent of hydroxyl groups on the phenylene ether oligomer have reacted with the monoanhydride.

Another embodiment is a composite core for an aluminum conductor composite core reinforced cable, the composite core comprising: two or more types of longitudinally oriented and substantially continuous reinforcing fibers selected from the group consisting of carbon fibers, poly(p-phenylene terephthalamide) fibers, basalt fibers, glass fibers, aramid fibers, boron fibers, liquid crystal fibers, and polyethylene fibers; and a cured epoxy material surrounding the reinforcing fibers, wherein the cured epoxy material is the product of reacting components comprising a phenylene ether oligomer, an anhydride hardener, and an epoxy resin; wherein said composite core has at least 50 volume percent fiber.

These and other embodiments are described in detail below.

### BRIEF DESCRIPTION OF THE DRAWINGS

FIG. 1 is a plot of percent weight increase versus time for cured samples immersed in 80° C. water.

FIG. 2 is a plot of percent change in sample length versus time for cured samples immersed in 80° C. water.

FIG. 3 is a plot of extent of reaction versus time for the reaction of phenylene ether oligomer with epoxy resin (C. Ex. 17), reaction of epoxy resin with anhydride hardener (C. Ex. 18), and reaction of phenylene ether oligomer with anhydride hardener (Ex. 9).

FIG. 4 is a plot of extent of reaction versus time for the reaction of a phenylene ether oligomer with an anhydride hardener in the absence of solvent.

FIG. 5 is a schematic cross-section of a composite core (1) for an aluminum conductor composite core reinforced cable; glass fibers (2) and carbon fibers (3) are interspersed in a cured epoxy material (4).

FIG. 6 is a schematic cross-section of a composite core (1) for an aluminum conductor composite core reinforced cable; the core comprises a central region of carbon fibers (3) in cured epoxy material (4), and a peripheral region of glass fibers (2) in cured epoxy material (4).

### DETAILED DESCRIPTION OF THE INVENTION

The present inventors have determined that increased heat resistance is exhibited by cured epoxy materials that have been prepared by a method in which a phenylene ether oligomer is pre-reacted with an anhydride hardener before the addition of epoxy resin. Cured epoxy materials prepared by the method also exhibit increased ductility relative to corresponding epoxy materials lacking phenylene ether oligomer.

One embodiment is a method of forming a cured epoxy material, the method comprising: reacting a phenylene ether oligomer with an anhydride hardener to form a first product; adding an epoxy resin to the first product to form a second product; and curing the second product to form a cured epoxy material.

The phenylene ether oligomer can have an intrinsic viscosity of 0.02 to 0.25 deciliter per gram, specifically 0.03 to 0.2 deciliter per gram, more specifically 0.05 to 0.15 deciliter per gram. Intrinsic viscosity can be determined by Ubbelohde viscometer at 25° C. in chloroform.

Phenylene ether oligomers include those comprising repeating structural units having the formula

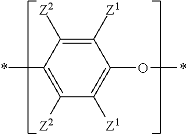

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In some embodiments, the phenylene ether oligomer has, on average, 1.5 to 3 hydroxyl groups per molecule, specifically 1.5 to 2.5 hydroxyl groups per molecule. Such phenylene ether oligomers can be prepared by copolymerization of a monohydric phenol such as 2,6-dimethylphenol or 2,3,6-trimethylphenol, and a dihydric phenol such as 2,2-bis(3,5-dimethyl-4-hydroxyphenyl)propane.

The anhydride hardener typically has a molecular weight of 98 to 400 grams per mole, specifically 98 to 200 grams per mole, and an average anhydride functionality of 1 to 2 anhydride groups per molecule. In some embodiments, the anhydride hardener is a monoanhydride (i.e., it has one anhydride group per molecule).

Specific anhydride hardeners include maleic anhydride, succinic anhydride, dodecenylsuccinic anhydride, cyclohexane-1,2-dicarboxylic anhydride, cis-4-cyclohexene-1,2-dicarboxylic acid anhydride, 4-methyl-4-cyclohexene-1,2-dicarboxylic acid anhydride, phthalic anhydride, hexahydro-o-phthalic anhydride, tetrahydrophthalic anhydride, methyltetrahydrophthalic anhydride, trimellitic anhydride, benzophenone tetracarboxylic acid dianhydride, ethylene glycol bis(trimellitate anhydride), glycerol tris(trimellitate anhydride), 5-norbornene-2,3-dicarbxylic anhydride, methyl-5-norbornene-2,3-dicarbxylic anhydride, and combinations thereof.

The phenylene ether oligomer and the anhydride hardener are typically reacted in amounts such that the initial ratio of hydroxyl groups on the phenylene ether oligomer to anhydride groups on the anhydride hardener is 0.03:1 to 0.27:1, specifically 0.04:1 to 0.26:1.

Reacting the phenylene ether oligomer with the anhydride hardener can be conducted either in the absence or presence of a solvent. Whether or not a solvent is used, the reaction temperature can be, for example, 50 to 160° C. Within this range, the reaction temperature can be 60 to 120° C., specifically 70 to 90° C. The reaction time will depend on the reaction temperature and can be, for example, ten minutes to ten hours.

When a solvent is used, its roles are to facilitate dissolution of the phenylene ether oligomer, the anhydride hardener, and the epoxy resin, to promote reaction of the phenylene ether oligomer with the anhydride hardener at the solvent's atmospheric boiling point, and to be readily and completely removed from the composition before it is cured. In some embodiments, the solvent has an atmospheric boiling point of 50 to 160° C., specifically 60 to 120° C., more specifically 70 to 90° C. In some embodiments, the solvent is selected from the group consisting of C₃-C₈ ketones, C₆-C₈ ethers, C₃-C₆ N,N-dialkylamides, C₆-C₁₀ aromatic hydrocarbons, C₁-C₃ chlorinated hydrocarbons, C₃-C₆ alkyl alkanoates, C₂-C₆ alkyl cyanides, C₂-C₄ dialkyl sulfoxides, and combinations thereof. In some embodiments, the solvent is selected from the group consisting of acetone, methyl ethyl ketone, methyl isobutyl ketone, ethyl acetate, isopropyl acetate, butyl acetate, dioxane, tetrahydrofuran, toluene, anisole, and combinations thereof.

When a solvent is employed for the reaction of the phenylene ether oligomer with an anhydride hardener, the solvent should be removed before the epoxy composition is cured. Solvent can be removed from the first product (comprising the reaction product of the phenylene ether oligomer and the anhydride hardener), the second product (comprising epoxy resin and the reaction product), or both.

The reaction of the phenylene ether oligomer and the anhydride hardener is preferably conduct to an extent that at least 75 mole percent of phenolic hydroxyl groups on the phenylene ether oligomer have reacted with the anhydride hardener. Within this limit, it is preferred that 85 mole percent, specifically 95 mole percent, of the phenolic hydroxyl groups have reacted. The extent of reaction of phenolic hydroxyl groups on the phenylene ether oligomer with the anhydride hardener can be determined, for example, by proton nuclear magnetic resonance spectroscopy (¹H NMR).

Another embodiment is a product of reacting a phenylene ether oligomer with a monoanhydride, wherein the phenylene ether oligomer has, on average, 1.5 to 3, specifically 1.5 to 2.5, hydroxyl groups per molecule, wherein the phenylene ether oligomer and the monoanhydride are reacted in amounts effective to provide an initial molar ratio of hydroxyl groups to anhydride groups of 0.04:1 to 0.26:1, and wherein in the product at least 75 mole percent, specifically at least 85 mole percent, more specifically at least 95 mole percent of hydroxyl groups on the phenylene ether oligomer have reacted with the monoanhydride.

In addition to the step of reacting the phenylene ether oligomer with the anhydride hardener to form a first product, the method includes adding an epoxy resin to the first product to form a second product. In some embodiments, the epoxy resin has an average epoxy functionality of 1.5 to 10 epoxy groups per molecule, and an epoxy equivalent weight of 90 to 500 grams per equivalent. Within the range of 1.5 to 10 epoxy groups per molecule, the average epoxy functionality can be 2 to 8 epoxy groups per molecule, specifically 3 to 6 epoxy groups per molecule. Within the range of 90 to 500 grams per equivalent, the epoxy equivalent weight can be 100 to 400 grams per equivalent, specifically 150 to 300 grams per equivalent.

In some embodiments, the epoxy resin is selected from the group consisting of N-glycidyl phthalimide, N-glycidyl tetrahydrophthalimide, phenyl glycidyl ether, p-butylphenyl glycidyl ether, styrene oxide, neohexene oxide, ethylene glycol diglycidyl ether, polyethylene glycol diglycidyl ether, propylene glycol diglycidyl ether, polypropylene glycol diglycidyl ether, tetramethyleneglycol diglycidyl ether, polytetramethylene glycol diglycidyl ether, adipic acid diglycidyl ester, sebacic acid diglycidyl ester, phthalic acid diglycidyl ester, bisphenol A diglycidyl ether, bisphenol F diglycidyl ether, bisphenol S diglycidyl ether, resorcinol diglycidyl ether, tetraglycidyldiaminodiphenylmethane, oligomers of the foregoing compounds, glycidyl ethers of phenol-formaldehyde novolac, glycidyl ethers of cresol-formaldehyde novolac, glycidyl ethers of t-butylphenol-formaldehyde novolac, glycidyl ethers of sec-butylphenol-formaldehyde novolac, glycidyl ethers of tert-octylphenol-formaldehyde novolac, glycidyl ethers of cumylphenol-formaldehyde novolac, glycidyl ethers of decylphenol-formaldehyde novolac, glycidyl ethers of bromophenol-formaldehyde novolac, glycidyl ethers of chlorophenol-formaldehyde novolac, glycidyl ethers of phenol-bis(hydroxymethyl)benzene novolac, glycidyl ethers of phenol-bis(hydroxymethylbiphenyl) novolac, glycidyl ethers of phenol-hydroxybenzaldehyde novolac, glycidyl ethers of phenol-dicyclopentadiene novolac, glycidyl ethers of naphthol-formaldehyde novolac, glycidyl ethers of naphthol-bis(hydroxymethyl)benzene novolac, glycidyl ethers of naphthol-bis(hydroxymethylbiphenyl) novolac, glycidyl ethers of naphthol-hydroxybenzaldehyde novolac, glycidyl ethers of naphthol-dicyclopentadiene novolac, triglycidyl ether of p-aminophenol, glycidyl ethers of cresol-formaldehyde novolac, BPA novolac epoxy, diglycidylether of 1,4 butane diol, epoxidized soybean oil, epoxidized castor oil, diglycidyl ether of neopentyl glycol, 2-ethylhexyl glycidyl ether, butyl glycidyl ether, phenyl glycidyl ether, t-butyl glycidyl ether, o-cresyl glycidyl ether, nonyl phenol glycidyl ether, cyclohexane dimethanol diglycidyl ether, trimethylol ethane triglycidyl ether, trimethylol propane triglycidyl ether, tetra glycidyl ether of meta-xylenediamine, tetraglycidyl ether of tetraphenolethane, dicyclopentadiene dioxide, 3,4-epoxy-cyclohexyl-methyl-3,4-epoxy-cyclohexyl carboxylate, diglycidyl ether of d-hydroxy naphthalene, and combinations thereof.

Adding the epoxy resin to the first product is conducted at a temperature high enough to facilitate mixing and not so high as to promote chemical reaction of the components. In some embodiments, adding the epoxy resin to the first product is conducted at a temperature of 60 to 120° C., specifically 70 to 100° C., more specifically 70 to 90° C. This step can be conducted in the presence or absence of solvent.

The product of adding the epoxy resin to the first product is referred to as the second product. In some embodiments, the second product is homogeneous. In some embodiments, at least 75 mole percent of phenolic hydroxyl groups on the phenylene ether oligomer have reacted with the anhydride hardener. Within this limit, the mole percent of phenolic hydroxyl groups reacted with anhydride hardener can be at least 85 mole percent, specifically at least 95 mole percent.

In some embodiments, the phenylene ether oligomer is used in an amount of 5 to 40 parts by weight, the anhydride hardener in an amount of 20 to 40 parts by weight, and the epoxy resin in an amount of 35 to 65 parts by weight, all based on 100 parts by weight total of the phenylene ether oligomer, the anhydride hardener, and the epoxy resin. Within the range of 5 to 40 parts by weight, the phenylene ether oligomer amount can be 10 to 35 parts by weight, specifically 10 to 30 parts by weight. Within the range of 20 to 40 parts by weight, the anhydride hardener amount can be 25 to 35 parts by weight. Within the range of 35 to 65 parts by weight, the epoxy resin amount can be 40 to 60 parts by weight.

As stated above, in some embodiments, the molar ratio of hydroxyl groups on the phenylene ether oligomer to anhydride groups on the anhydride hardener is 0.03:1 to 0.27:1, specifically 0.04:1 to 0.26:1. In some embodiments, the molar ratio of hydroxyl groups on the phenylene ether oligomer to epoxy groups on the epoxy resin is 0.03:1 to 0.14:1, specifically 0.04:1 to 0.12:1. In some embodiments, the molar ratio of anhydride groups on the anhydride hardener to epoxy groups on the epoxy resin is 0.3:1 to 0.8:1, specifically 0.4:1 to 0.75:1.

The method further includes curing the second product to form a cured epoxy material. As demonstrated in the working examples below, curing is typically conducted at a series of increasing temperatures. In some embodiments, curing the curable composition is conducted at a maximum temperature of 170 to 240° C., specifically 190 to 230° C., more specifically 200 to 230° C.

Curing can, optionally, be conducted in the presence of a curing promoter. When present, the curing promoter can be added before or during the reaction of the phenylene ether oligomer with the anhydride hardener, or before, during, or after the addition of the epoxy resin to the first product. Examples of suitable curing promoters include isophoronediamine, triethylenetetraamine, diethylenetriamine, aminoethylpiperazine, 1,2- and 1,3-diaminopropane, 2,2-dimethylpropylenediamine, 1,4-diaminobutane, 1,6-diaminohexane, 1,7-diaminoheptane, 1,8-diaminooctane, 1,9-diaminononane, 1,12-diaminododecane, 4-azaheptamethylenediamine, N,N′-bis(3-aminopropyl)butane-1,4-diamine, cyclohexanediamine, dicyandiamine, diamide diphenylmethane, diamide diphenylsulfonic acid (amine adduct), 4,4′-methylenedianiline, diethyltoluenediamine, m-phenylene diamine, melamine formaldehyde, tetraethylenepentamine, 3-diethylaminopropylamine, 3,3′-iminobispropylamine, 2,4-bis(p-aminobenzyl)aniline, tetraethylenepentamine, 3-diethylaminopropylamine, 2,2,4- and 2,4,4-trimethylhexamethylenediamine, 1,2- and 1,3-diaminocyclohexane, 1,4-diamino-3,6-diethylcyclohexane, 1,2-diamino-4-ethylcyclohexane, 1,4-diamino-3,6-diethylcyclohexane, 1-cyclohexyl-3,4-diminocyclohexane, 4,4′-diaminondicyclohexylmethane, 4,4′-diaminodicyclohexylpropane, 2,2-bis(4-aminocyclohexyl)propane, 3,3′-dimethyl-4,4′-diamiondicyclohexylmethane, 3-amino-1-cyclohexaneaminopropane, 1,3- and 1,4-bis(aminomethyl)cyclohexane, m- and p-xylylenediamine, diethyl toluene diamines, triethylamine, tributylamine, dimethylaniline, diethylaniline, a-methylbenzyldimethylamine, N,N-dimethylaminoethanol, N,N-dimethylaminocresol, tri(N,N-dimethylaminomethyl)phenol, 2-methylimidazole, 2-ethylimidazole, 2-laurylimidazole, 2-heptadecylimidazole, 2-phenylimidazole, 4-methylimidazole, 4-ethylimidazole, 4-laurylimidazole, 4-heptadecylimidazole, 2-phenyl-4-methylimidazole, 2-phenyl-4-hydroxymethylimidazole, 2-ethyl-4-methylimidazole, 2-ethyl-4-hydroxymethylimidazole, 1-cyanoethyl-4-methylimidazole, 2-phenyl-4,5-dihydroxymethylimidazole, and combinations thereof. When present, the curing promoter can be used in an amount of 0.02 to 2 parts by weight, specifically 0.04 to 0.4 parts by weight, per 100 parts by weight epoxy resin.

In addition to the phenylene ether oligomer, the anhydride hardener, and the epoxy resin, the components used to form the cured epoxy material can include fillers, reinforcing agents, additives, or a combination thereof.

Suitable fillers and reinforcing agents may be in the form of nanoparticles, that is, particles with a median particle size (D₅₀) smaller than 100 nanometers as determined using light scattering methods. Useful fillers or reinforcing agents include, for example, silicates and silica powders such as aluminum silicate (mullite), synthetic calcium silicate, zirconium silicate, fused silica, crystalline silica graphite, and natural silica sand; boron powders such as boron-nitride powder, and boron-silicate powders; oxides such as TiO₂, aluminum oxide, and magnesium oxide; calcium sulfate (as its anhydride, dihydrate or trihydrate); calcium carbonates such as chalk, limestone, marble, and synthetic precipitated calcium carbonates; talc, including fibrous, modular, needle shaped, and lamellar talc; wollastonite; surface-treated wollastonite; glass spheres such as hollow and solid glass spheres, silicate spheres, cenospheres, and aluminosilicate spheres (armospheres); kaolin, including hard kaolin, soft kaolin, calcined kaolin, and kaolin comprising various coatings known in the art to facilitate compatibility with the polymeric matrix resin; single crystal fibers or “whiskers” such as silicon carbide, alumina, boron carbide, iron, nickel, and copper whiskers; fibers (including continuous and chopped fibers) such as carbon fibers (including carbon nanofibers), glass fibers (such as E, A, C, ECR, R, S, D, and NE glass fibers), basalt fibers, ceramic fibers, aramid fibers (including poly(p-phenylene terephthalamide) fibers), boron fibers, liquid crystal fibers, and polyethylene fibers; sulfides such as molybdenum sulfide, and zinc sulfide; barium compounds such as barium titanate, barium ferrite, barium sulfate, and heavy spar; metals and metal oxides such as particulate and fibrous aluminum, bronze, zinc, copper and nickel; flaked fillers such as glass flakes, flaked silicon carbide, aluminum diboride, aluminum flakes, and steel flakes; inorganic fibrous fillers, for example short inorganic fibers such as those derived from blends comprising at least one of aluminum silicates, aluminum oxides, magnesium oxides, and calcium sulfate hemihydrate; natural fillers and reinforcements, such as wood flour obtained by pulverizing wood, fibrous products such as cellulose, cotton, sisal, jute, starch, cork flour, lignin, ground nut shells, corn, and rice grain husks; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, and poly(vinyl alcohol); as well as additional fillers and reinforcing agents such as mica, clay, feldspar, flue dust, fillite, quartz, quartzite, perlite, tripoli, diatomaceous earth, and carbon black; as well as combinations of the foregoing fillers and reinforcing agents. When present, fillers and reinforcing agents are typically present in an amount of 5 to 90 weight percent, based on the total weight of the cured epoxy material. Within this range, the content of fillers and reinforcing agents can be 10 to 80 weight percent, specifically 20 to 80 weight percent, more specifically 40 to 80 weight percent, even more specifically 50 to 80 weight percent.

Suitable additives include colorants (including dyes and pigments), antioxidants, heat stabilizers, light stabilizers, plasticizers, lubricants, flow modifiers, drip retardants, flame retardants, antistatic agents, flow-promoting agents, processing aids, substrate adhesion agents, mold release agents, toughening agents, low-profile additives, stress-relief additives, and combinations thereof. When present, additives are typically used in an amount of 0.5 to 10 weight percent, specifically 1 to 5 weight percent, based on the total weight of the cured epoxy material.

An important advantage of the present method is that it produces a cured epoxy material with greater heat resistance than a corresponding material produced without pre-reacting the phenylene ether oligomer and the anhydride hardener. The improved heat resistance can be manifested, for example, as an increased glass transition temperature. Thus, in some embodiments, the cured epoxy material exhibits a glass transition temperature of 150 to 250° C., specifically 170 to 230° C., more specifically 180 to 225° C., measured by differential scanning calorimetry. The cured epoxy material also exhibits good ductility, which is a characteristic of epoxy compositions containing phenylene ether oligomer and, as shown below in the working examples, relatively independent of their method of preparation. The good ductility can be manifested as an unnotched Izod impact strength of 80 to 200 joules/meter, specifically 100 to 200 joules/meter, at 23° C. determined according to ASTM D 4812-11 at 23° C. To summarize, compared to cured epoxy compositions containing phenylene ether oligomer and prepared by other methods, the cured epoxy composition prepared by the current method exhibits improved heat resistance and comparable impact strength. And compared to cured epoxy compositions lacking phenylene ether oligomer, the cured epoxy composition prepared by the current method exhibits comparable heat resistance and improved impact strength.

In a very specific embodiment of the method, reacting a phenylene ether oligomer with an anhydride hardener is conducted at a temperature of 60 to 120° C.; the phenylene ether oligomer has an intrinsic viscosity of 0.03 to 0.2 deciliter per gram, measured at 25° C. in chloroform, and, on average, 1.5 to 2.5 hydroxyl groups per molecule; the anhydride hardener comprises a monoanhydride having a molecular weight of 98 to 200 grams per mole; said reacting a phenylene ether oligomer with an anhydride hardener is conducted in the presence of a solvent, and the method further comprises removing solvent from the first product, the second product, or both; the phenylene ether oligomer is used in an amount of 5 to 40 parts by weight, the anhydride hardener in an amount of 20 to 40 parts by weight, and the epoxy resin in an amount of 35 to 65 parts by weight, all based on 100 parts by weight total of the phenylene ether oligomer, the anhydride hardener, and the epoxy resin; curing the second product is conducted at a maximum temperature of 180 to 250° C.; and the cured epoxy material exhibits a glass transition temperature of 150 to 250° C. measured by differential scanning calorimetry, and an unnotched Izod impact strength of 80 to 200 joules/meter, specifically 100 to 200 joules/meter, at 23° C. determined according to ASTM D 4812-11 at 23° C.

Another embodiment is a cured epoxy material formed by the method in any of its above-described variations and exhibiting a glass transition temperature of 150 to 250° C. measured by differential scanning calorimetry, and an unnotched Izod impact strength of 80 to 200 joules/meter, specifically 100 to 200 joules/meter, at 23° C. determined according to ASTM D 4812-11 at 23° C.

Another embodiment is a composite core for an aluminum conductor composite core reinforced cable, the composite core comprising: two or more types of longitudinally oriented and substantially continuous reinforcing fibers selected from the group consisting of carbon fibers (including carbon nanofibers), basalt fibers, glass fibers, ceramic fibers, aramid fibers (including poly(p-phenylene terephthalamide) fibers), boron fibers, liquid crystal fibers, and polyethylene fibers (including high performance polyethylene fibers); and a cured epoxy material surrounding the reinforcing fibers, wherein the cured epoxy material is the product of reacting components comprising a phenylene ether oligomer, an epoxy resin, and a curing promoter; wherein said composite core has at least 50 volume percent fiber. One advantage of the composite core is that it is resistant high temperatures. For example, in some embodiments, the composite core has an operating capability in the range of 90 to 230° C.

In some embodiments, the two or more types of longitudinally oriented and substantially continuous reinforcing fibers selected from the group consisting of carbon fibers, glass fibers, and ceramic fibers.

Aluminum conductor composite core reinforced cable is generally known. See, for example, D. M. Wilson et al., U.S. Patent Application Publication No. US 2013/0167502 A1, and C. Hiel et al., U.S. Patent Application Publication No. US 2010/0163275 A1. The present composite differs from prior art composite cores at least in its incorporation of phenylene ether oligomer.

The cured epoxy material is the product of reacting components comprising a phenylene ether oligomer, an epoxy resin, and a curing promoter. Curing promoters for epoxy resins are described above.

In some embodiments, the curing promoter comprises an anhydride hardener, and reacting the phenylene ether oligomer, the epoxy resin, and the curing promoter comprises reacting the phenylene ether oligomer with the anhydride hardener to form a first product; adding the epoxy resin and the fibers to the first product to form a second product; and curing the second product to form the cured epoxy material surrounding the fibers.

In other embodiments, the phenylene ether oligomer is reacted with the epoxy resin, and the resulting product is reacted with the curing promoter. In still other embodiments, the phenylene ether oligomer, the epoxy resin, and the curing promoter are reacted simultaneously.

In any of these embodiments, a pultrusion process can be used to incorporate the fibers into the uncured epoxy material, and to cure the epoxy material surrounding the fibers.

All of the variations described above in the context of the method of forming a cured epoxy material apply as well to the composite core.

The composite core has at least 50 volume percent fiber. Within this limit, the volume percent fiber can be 50 to 90, specifically 50 to 80, more specifically 60 to 80.

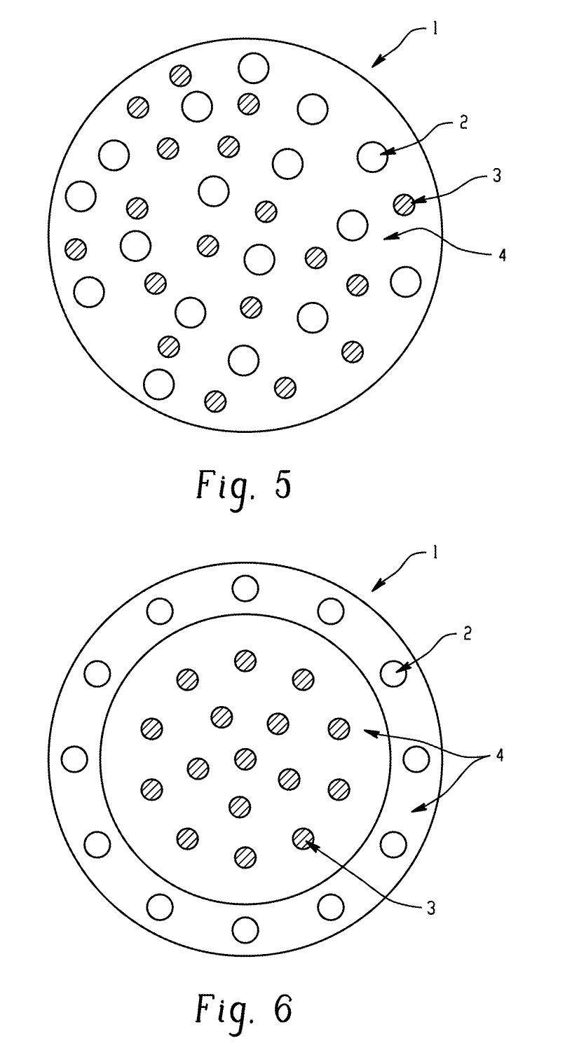

FIG. 5 is a schematic cross-section of a composite core (1) for an aluminum conductor composite core reinforced cable; glass fibers (2) and carbon fibers (3) are interspersed in a cured epoxy material (4).

FIG. 6 is a schematic cross-section of a composite core (1) for an aluminum conductor composite core reinforced cable; the core comprises a central region of carbon fibers (3) in cured epoxy material (4), and a peripheral region of glass fibers (2) in cured epoxy material (4).

The invention includes at least the following embodiments.

### Embodiment 1

A method of forming a cured epoxy material, the method comprising: reacting a phenylene ether oligomer with an anhydride hardener to form a first product; adding an epoxy resin to the first product to form a second product; and curing the second product to form a cured epoxy material.

### Embodiment 2

The method of embodiment 1, wherein said reacting a phenylene ether oligomer with an anhydride hardener is conducted at a temperature of 50 to 160° C.

### Embodiment 3

The method of embodiment 2, wherein said reacting a phenylene ether oligomer with an anhydride hardener is conducted in the presence of a solvent selected from the group consisting of C₃-C₈ ketones, C₆-C₈ ethers, C₃-C₆ N,N-dialkylamides, C₆-C₁₀ aromatic hydrocarbons, C₁-C₃ chlorinated hydrocarbons, C₃-C₆ alkyl alkanoates, C₂-C₆ alkyl cyanides, C₂-C₄ dialkyl sulfoxides, and combinations thereof.

### Embodiment 4

The method of any one of embodiments 1-3, wherein the first product is a homogeneous solution in which at least 75 mole percent of phenolic hydroxyl groups on the phenylene ether oligomer have reacted with the anhydride hardener.

### Embodiment 5

The method of any one of embodiments 1-4, wherein said adding an epoxy resin to the first product is conducted at a temperature of 60 to 120° C.

### Embodiment 6

The method of any one of embodiments 1-5, wherein the second product is a homogeneous solution in which at least 75 mole percent of phenolic hydroxyl groups on the phenylene ether oligomer have reacted with the anhydride hardener.

### Embodiment 7

The method of any one of embodiments 1-6, wherein said curing the second product is conducted at a maximum temperature of 170 to 220° C.

### Embodiment 8

The method of any one of embodiments 1-7, wherein the phenylene ether oligomer is used in an amount of 5 to 40 parts by weight, the anhydride hardener in an amount of 20 to 40 parts by weight, and the epoxy resin in an amount of 35 to 65 parts by weight, all based on 100 parts by weight total of the phenylene ether oligomer, the anhydride hardener, and the epoxy resin.

### Embodiment 9

The method of any one of embodiments 1-8, wherein the phenylene ether oligomer has an intrinsic viscosity of 0.03 to 0.2 deciliter per gram, measured at 25° C. in chloroform.

### Embodiment 10

The method of any one of embodiments 1-9, wherein the phenylene ether oligomer has, on average, 1.5 to 3 hydroxyl groups per molecule.

### Embodiment 11

The method of any one of embodiments 1-10, wherein the anhydride hardener comprises a monoanhydride having a molecular weight of 98 to 400 grams per mole.

### Embodiment 12

The method of any one of embodiments 1-11, wherein the anhydride hardener is selected from the group consisting of maleic anhydride, succinic anhydride, dodecenylsuccinic anhydride, cyclohexane-1,2-dicarboxylic anhydride, cis-4-cyclohexene-1,2-dicarboxylic acid anhydride, 4-methyl-4-cyclohexene-1,2-dicarboxylic acid anhydride, phthalic anhydride, hexahydro-o-phthalic anhydride, tetrahydrophthalic anhydride, methyltetrahydrophthalic anhydride, trimellitic anhydride, benzophenone tetracarboxylic acid dianhydride, ethylene glycol bis(trimellitate anhydride), glycerol tris(trimellitate anhydride), 5-norbornene-2,3-dicarbxylic anhydride, methyl-5-norbornene-2,3-dicarbxylic anhydride, and combinations thereof.

### Embodiment 13

The method of any one of embodiments 1-12, wherein the epoxy resin has an average epoxy functionality of 1.5 to 10 epoxy groups per molecule, and an epoxy equivalent weight of 90 to 500 grams per equivalent.

### Embodiment 14

The method of any one of embodiments 1-13, wherein the epoxy resin is selected from the group consisting of N-glycidyl phthalimide, N-glycidyl tetrahydrophthalimide, phenyl glycidyl ether, p-butylphenyl glycidyl ether, styrene oxide, neohexene oxide, ethylene glycol diglycidyl ether, polyethylene glycol diglycidyl ether, propylene glycol diglycidyl ether, polypropylene glycol diglycidyl ether, tetramethyleneglycol diglycidyl ether, polytetramethylene glycol diglycidyl ether, adipic acid diglycidyl ester, sebacic acid diglycidyl ester, phthalic acid diglycidyl ester, bisphenol A diglycidyl ether, bisphenol F diglycidyl ether, bisphenol S diglycidyl ether, resorcinol diglycidyl ether, tetraglycidyldiaminodiphenylmethane, oligomers of the foregoing compounds, glycidyl ethers of phenol-formaldehyde novolac, glycidyl ethers of cresol-formaldehyde novolac, glycidyl ethers of t-butylphenol-formaldehyde novolac, glycidyl ethers of sec-butylphenol-formaldehyde novolac, glycidyl ethers of tert-octylphenol-formaldehyde novolac, glycidyl ethers of cumylphenol-formaldehyde novolac, glycidyl ethers of decylphenol-formaldehyde novolac, glycidyl ethers of bromophenol-formaldehyde novolac, glycidyl ethers of chlorophenol-formaldehyde novolac, glycidyl ethers of phenol-bis(hydroxymethyl)benzene novolac, glycidyl ethers of phenol-bis(hydroxymethylbiphenyl) novolac, glycidyl ethers of phenol-hydroxybenzaldehyde novolac, glycidyl ethers of phenol-dicyclopentadiene novolac, glycidyl ethers of naphthol-formaldehyde novolac, glycidyl ethers of naphthol-bis(hydroxymethyl)benzene novolac, glycidyl ethers of naphthol-bis(hydroxymethylbiphenyl) novolac, glycidyl ethers of naphthol-hydroxybenzaldehyde novolac, glycidyl ethers of naphthol-dicyclopentadiene novolac, triglycidyl ether of p-aminophenol, glycidyl ethers of cresol-formaldehyde novolac, BPA novolac epoxy, diglycidylether of 1,4 butane diol, epoxidized soybean oil, epoxidized castor oil, diglycidyl ether of neopentyl glycol, 2-ethylhexyl glycidyl ether, butyl glycidyl ether, phenyl glycidyl ether, t-butyl glycidyl ether, o-cresyl glycidyl ether, nonyl phenol glycidyl ether, cyclohexane dimethanol diglycidyl ether, trimethylol ethane triglycidyl ether, trimethylol propane triglycidyl ether, tetra glycidyl ether of meta-xylenediamine, tetraglycidyl ether of tetraphenolethane, dicyclopentadiene dioxide, 3,4-epoxy-cyclohexyl-methyl-3,4-epoxy-cyclohexyl carboxylate, diglycidyl ether of d-hydroxy naphthalene, and combinations thereof.

### Embodiment 15

The method of any one of embodiments 1-14, wherein the cured epoxy material exhibits a glass transition temperature of 150 to 250° C. measured by differential scanning calorimetry, and an unnotched Izod impact strength of 80 to 200 joules/meter, specifically 100 to 200 joules/meter, at 23° C. determined according to ASTM D 4812-11 at 23° C.

### Embodiment 16

The method of embodiment 1, wherein said reacting a phenylene ether oligomer with an anhydride hardener is conducted at a temperature of 60 to 120° C.; wherein the phenylene ether oligomer has an intrinsic viscosity of 0.03 to 0.2 deciliter per gram, measured at 25° C. in chloroform, and, on average, 1.5 to 2.5 hydroxyl groups per molecule; wherein the anhydride hardener comprises a monoanhydride having a molecular weight of 98 to 200 grams per mole; wherein said reacting a phenylene ether oligomer with an anhydride hardener is conducted in the presence of a solvent; and wherein the method further comprises removing solvent from the first product, the second product, or both; wherein the phenylene ether oligomer is used in an amount of 5 to 40 parts by weight, the anhydride hardener in an amount of 20 to 40 parts by weight, and the epoxy resin in an amount of 35 to 65 parts by weight, all based on 100 parts by weight total of the phenylene ether oligomer, the anhydride hardener, and the epoxy resin; wherein said curing the second product is conducted at a maximum temperature of 180 to 250° C.; and wherein the cured epoxy material exhibits a glass transition temperature of 150 to 250° C. measured by differential scanning calorimetry, and an unnotched Izod impact strength of 80 to 200 joules/meter, specifically 100 to 200 joules/meter, at 23° C. determined according to ASTM D 4812-11 at 23° C.

### Embodiment 17

A cured epoxy material formed by the method of any one of embodiments 1-16 and exhibiting a glass transition temperature of 150 to 250° C. measured by differential scanning calorimetry, and an unnotched Izod impact strength of 80 to 200 joules/meter, specifically 100 to 200 joules/meter, at 23° C. determined according to ASTM D 4812-11 at 23° C.

### Embodiment 18

A product of reacting a phenylene ether oligomer with a monoanhydride, wherein the phenylene ether oligomer has, on average, 1.5 to 3 hydroxyl groups per molecule, wherein the phenylene ether oligomer and the monoanhydride are reacted in amounts effective to provide an initial molar ratio of hydroxyl groups to anhydride groups of 0.04:1 to 0.26:1, and wherein in the product at least 75 mole percent of hydroxyl groups on the phenylene ether oligomer have reacted with the monoanhydride.

### Embodiment 19

A composite core for an aluminum conductor composite core reinforced cable, the composite core comprising: two or more types of longitudinally oriented and substantially continuous reinforcing fibers selected from the group consisting of carbon fibers, basalt fibers, glass fibers, ceramic fibers, aramid fibers, boron fibers, liquid crystal fibers, and polyethylene fibers; and a cured epoxy material surrounding the reinforcing fibers, wherein the cured epoxy material is the product of reacting components comprising a phenylene ether oligomer, an epoxy resin, and a curing promoter; wherein said composite core has at least 50 volume percent fiber.

### Embodiment 20

The composite core of embodiment 19, wherein the curing promoter comprises an anhydride hardener, and wherein the reacting the phenylene ether oligomer, the epoxy resin, and the curing promoter comprises reacting the phenylene ether oligomer with the anhydride hardener to form a first product; adding the epoxy resin and the fibers to the first product to form a second product; and curing the second product to form the cured epoxy material surrounding the fibers; or wherein the reacting the phenylene ether oligomer, the epoxy resin, and the curing promoter comprises reacting the phenylene ether oligomer with the epoxy resin to form a first product; adding the curing promoter and the fibers to the first product to form a second product; and curing the second product to form cured epoxy material surrounding the fibers.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### Examples 1-3, Comparative Examples 1-6

The components used in the examples are described in Table 1.

TABLE 1

| Component | Description |
|---|---|
| DGEBPA | Diglycidyl ether of bisphenol A, CAS Reg. No. 25068-38-6; obtained as |
| | DER ™ 332 from Dow Chemical. |
| TGDDM | Tetraglycidyldiaminodiphenylmethane, CAS Reg. No. 28768-32-3; |
| | obtained as ARALDITE ™ MY 721 from Huntsman Advanced Materials. |
| Me-NADIC | Methyl-5-norbornene-2,3-dicarboxylic anhydride, CAS Reg. No. 25134-21- |
| | 8; obtained from Sigma-Aldrich. |
| NADIC | cis-5-Norbornene-endo-2,3-dicarboxylic anhydride; CAS Reg. No. 129-64- |
| | 6; obtained from Sigma Aldrich. |
| HHPA | Hexahydrophthalic anhydride, CAS Reg. No. 85-42-7; obtained from Miller |
| | Stephenson Co. |
| PPE-2OH 0.09 | Copolymer of 2,6-dimethylphenol and 2,2-bis(3,5-dimethyl-4- |
| | hydroxyphenyl)propane, CAS Reg. No. 1012321-47-9, the copolymer |
| | having an average of about 2 hydroxyl groups per molecule, a glass |
| | transition temperature of about 150° C., and an intrinsic viscosity of about |
| | 0.09 deciliter per gram measured at 25° C. in chloroform; OH content |
| | equivalent to 64.44 milligrams KOH/gram copolymer; equivalent weight |
| | (weight per hydroxyl group) = 872 atomic mass units; obtained as PPO ™ |
| | SA90 Resin from Sabic Innovative Plastics. |
| PPE-2OH 0.12 | Copolymer of 2,6-dimethylphenol and 2,2-bis(3,5-dimethyl-4- |
| | hydroxyphenyl)propane, CAS Reg. No. 1012321-47-9, the copolymer |
| | having an average of about 2 hydroxyl groups per molecule, a glass |
| | transition temperature of about 170° C., and an intrinsic viscosity of about |
| | 0.12 deciliter per gram measured at 25° C. in chloroform; OH content |
| | equivalent to 35.1 milligrams KOH/gram copolymer; equivalent weight |
| | (weight per hydroxyl group) = 1597 atomic mass units; preparable |
| | according to the procedure of U.S. Pat. No. 7,655,278 to Braidwood et |
| | al., columns 24-25. |
| PPE-2OH 0.06 | Copolymer of 2,6-dimethylphenol and 2,2-bis(3,5-dimethyl-4- |
| | hydroxyphenyl)propane, CAS Reg. No. 1012321-47-9, the copolymer |
| | having an average of about 2 hydroxyl groups per molecule, a glass |
| | transition temperature of about 100° C., and an intrinsic viscosity of about |
| | 0.06 deciliter per gram measured at 25° C. in chloroform; OH content |
| | equivalent to 82.38 milligrams KOH/gram copolymer; equivalent weight |
| | (weight per hydroxyl group) = 681 atomic mass units; preparable according |
| | to the procedure of U.S. Pat. No. 7,655,278 to Braidwood et al., columns |
| | 24-25. |
| 1-MI | 1-Methylimidazole, CAS Reg. No. 616-47-7; obtained from Sigma Aldrich. |
| DMAP | 4-(Dimethylamino)pyridine, CAS Reg. No. 1122-58-3; obtained from Sigma |
| | Aldrich. |

Formulations are summarized in Table 2, where component amounts are expressed in parts by weight per 100 parts resin, where “resin” is defined as the sum of epoxy (TGDDM), anhydride hardener (Me-NADIC), and phenylene ether oligomer (PPE-2OH 0.09).

TABLE 2

| | PPE-2OH | | | |
|---|---|---|---|---|
| | 0.09 | TGDDM | Me-NADIC | 1-MI |
| C. Ex. 1 | 10.12 | 55.64 | 34.25 | 0.13 |
| C. Ex. 2 | 20.02 | 50.05 | 29.93 | 0.13 |
| C. Ex. 3 | 29.73 | 44.60 | 25.67 | 0.13 |
| C. Ex. 4 | 10.12 | 55.64 | 34.25 | 0.13 |
| C. Ex. 5 | 20.02 | 50.05 | 29.93 | 0.13 |
| C. Ex. 6 | 29.73 | 44.60 | 25.67 | 0.13 |
| Ex. 1 | 10.12 | 55.64 | 34.25 | 0.13 |
| Ex. 2 | 20.02 | 50.05 | 29.93 | 0.13 |
| Ex. 3 | 29.73 | 44.60 | 25.67 | 0.13 |

For Comparative Examples 1-3, all components were mixed, and the resulting mixture cured. The TGDDM, PPE-2OH 0.09, Me-NADIC, and 1-MI were dissolved in methyl ethyl ketone (MEK) at 80° C. The MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

For Comparative Examples 4-6, the PPE-2OH 0.09 was pre-reacted with TGDDM before Me-NADIC was added and the resulting mixture cured. The TGDDM, PPE-2OH 0.09, and 1-MI were dissolved in MEK at 80° C. The solution was held at 80° C. for 60 minutes. Then the Me-NADIC was added and dissolved. MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

For Examples 1-3, the PPE-2OH was pre-reacted with Me-NADIC before TGDDM was added and the resulting mixture cured. The PPE-2OH, Me-NADIC, and 1-MI were dissolved in MEK at 80° C. The solution was held at 80° C. for 60 minutes. Then TGDDM was added and dissolved. MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

Glass transition temperatures were determined by differential scanning calorimetry (DSC) and summarized in Table 3. Clearly, cured materials made by a method including pre-reacting the phenylene ether oligomer with the anhydride (Examples 1-3) gave significantly higher glass transition temperature values than cured materials made by a method including mixing all components simultaneously (Comparative Examples 1-3) or by a method including pre-reacting phenylene ether oligomer and epoxy resin (Comparative Examples 4-6).

TABLE 3

| | T_{g} (° C.) |
|---|---|
| C. Ex. 1 | 176.4 |
| C. Ex. 2 | 181.7 |
| C. Ex. 3 | 195.9 |
| C. Ex. 4 | 188.2 |
| C. Ex. 5 | 188.7 |
| C. Ex. 6 | 199.3 |
| Ex. 1 | 221.3 |
| Ex. 2 | 220.6 |
| Ex. 3 | 220.5 |

### Comparative Example 7

This example illustrates the preparation and properties of a cured epoxy material without phenylene ether oligomer. TGDDM, Me-NADIC, and 1-MI were mixed together to form a homogeneous solution. The formulation is summarized in Table 4. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

TABLE 4

| | PPE-2OH | | | |
|---|---|---|---|---|
| | 0.09 | TGDDM | Me-NADIC | 1-MI |
| C. Ex. 7 | 0.00 | 61.32 | 38.68 | 0.13 |

Table 5 compares the properties of phenylene ether oligomer-containing Examples 1, 2, and 3 with those of phenylene ether oligomer-free Comparative Example 7. Glass transition temperature values, expressed in degrees centigrade, were determined by DSC. Unnotched Izod impact strength values, expressed in units of joules per meter, were determined according to ASTM D 4812-11 at 23° C. using a test bar with cross-sectional dimensions of 3.2 by 12.7 millimeters. Density values, expressed in units of grams per cubic centimeter, were determined according to ASTM D 792-08 at 23° C. Dielectric constant (Dₖ) and loss tangent (D_{f}) values, which are unitless, were determined according to IPC-TM-650-2.5.5.9 at 23° C. and 1 gigahertz. Shrinkage values, expressed in units of percent, were determined on cured castings. After the mold and casting were cooled to room temperature, the width of the mold was measured in three locations and the width of the cured epoxy was measured in the same three locations. The averages of the mold and casting measurements were determined. The percent shrinkage was determined by the following equation:

Percent shrinkage=100×[(width mold−width casting)/(width mold)].

As previously observed, the Example 1, 2, and 3 cured materials prepared by pre-reacting the phenylene ether oligomer with the anhydride hardener exhibit substantially higher T_{g} values that the Comparative Example 1, 2, and 3 cured materials prepared by mixing all components before curing.

Relative to the Comparative Example 7 cured material, prepared without phenylene ether oligomer, the Example 1, 2, and 3 cured materials exhibit comparable T_{g} values but substantially higher impact strength values, and lower density, dielectric constant (Dₖ), and loss tangent (D_{f}) values. Indeed, over the range studied, the impact strength increased over 180%. In addition, there are major decreases in shrinkage during curing. Shrinkage can have negative effects on the performance of composites. Shrinkage leads to the formation of residual stresses which can have adverse effects on the mechanical performance via interface debonding and matrix micro-cracking.

TABLE 5

| | | Impact | | | | |
|---|---|---|---|---|---|---|
| | | strength | Density, | | | Shrinkage |
| | T_{g} (° C.) | (J/m) | (g/cc) | Dk @ 1 GHz | Df @ 1 GHz | (%) |
| C. Ex. 1 | 176.4 | 99 | 1.2226 | 3.097 | 0.0170 | — |
| C. Ex. 2 | 181.7 | 141 | 1.2093 | 3.062 | 0.0157 | — |
| C. Ex. 3 | 195.9 | 187 | 1.1974 | 3.033 | 0.0142 | — |
| C. Ex. 7 | 223.4 | 66.8 | 1.2347 | 3.130 | 0.0184 | 1.58 |
| Ex. 1 | 221.3 | 103 | 1.2227 | 3.098 | 0.0171 | 1.03 |
| Ex. 2 | 220.6 | 147 | 1.2094 | 3.061 | 0.0156 | 0.64 |
| Ex. 3 | 220.5 | 191 | 1.1975 | 3.033 | 0.0141 | 0.46 |

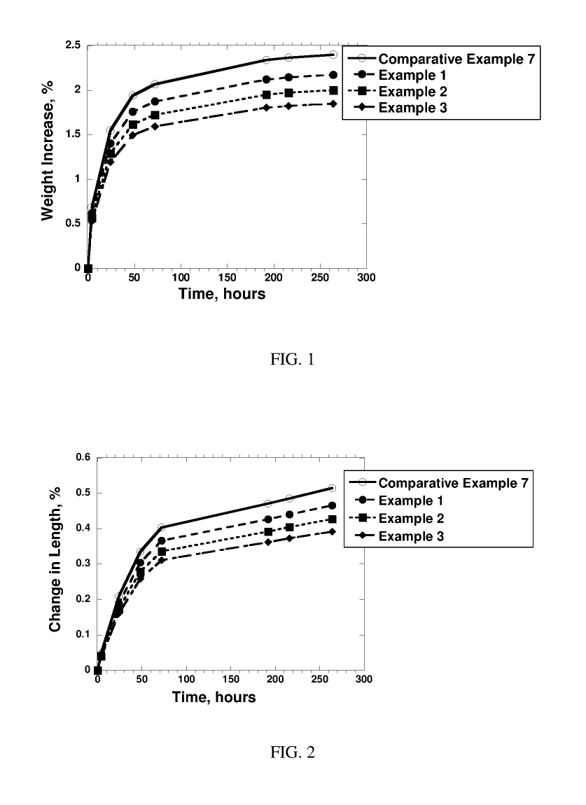

Low moisture absorption is important in composites. Absorbed moisture can have adverse effects on performance. Besides increasing the weight of the composite, absorbed water will act as a plasticizer and lower properties. In addition, absorbed water can lead to hygroscopic stress through differential swelling, reduces interfacial adhesion, and induce corrosion. Samples were immersed in water absorption at 80° C. and changes in weight and length were measured versus immersion time. FIG. 1 is a plot of water absorption versus immersion time. Increasing PPE-2OH content is associated with decreasing water absorption. FIG. 2 is a plot of sample length versus immersion time. Increasing PPE-2OH content is associated with increasing dimensional stability after immersion in water.

### Examples 4-6, Comparative Examples 8-14

These examples further illustrate the effects of pre-reacting phenylene ether oligomer with anhydride hardener. In these experiments, the epoxy resin was DGEBPA and the anhydride hardener was NADIC. Formulations are summarized in Table 6, where component amounts are expressed in units of parts by weight per 100 parts resin, where “resin” is defined as the sum of epoxy (DGEBPA), anhydride hardener (NADIC), and phenylene ether oligomer (PPE-2OH 0.09). All examples were formulated with about 10-12% excess epoxy equivalents.

TABLE 6

| | PPE-2OH 0.09 | DGEBPA | NADIC | 1-MI |
|---|---|---|---|---|
| C. Ex. 8 | 10.14 | 64.23 | 25.63 | 0.16 |
| C. Ex. 9 | 20.08 | 58.00 | 21.92 | 0.16 |
| C. Ex. 10 | 30.08 | 51.52 | 18.40 | 0.16 |
| C. Ex. 11 | 10.40 | 64.92 | 24.68 | 0.16 |
| C. Ex. 12 | 20.48 | 58.48 | 21.04 | 0.16 |
| C. Ex. 13 | 30.57 | 51.82 | 17.61 | 0.16 |
| C. Ex. 14 | 0.00 | 70.43 | 29.57 | 0.16 |
| Ex. 4 | 10.14 | 64.23 | 25.63 | 0.16 |
| Ex. 5 | 20.08 | 58.00 | 21.92 | 0.16 |
| Ex. 6 | 30.08 | 51.52 | 18.40 | 0.16 |

For Comparative Examples 8-10, the PPE-2OH 0.09 was pre-reacted with DGEBPA before the NADIC was added and the resulting mixture cured. The PPE-2OH 0.09 was dissolved in methyl ethyl ketone (MEK) at 80° C. Then DGEBPA and 1-MI were added. The solution was held at 80° C. with stirring for 60 minutes. Then the NADIC was added and dissolved. The MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

For Comparative Examples 11-13, the NADIC was pre-reacted with DGEBPA before PPE-2OH 0.09 was added and the resulting mixture cured. The DGEBPA, NADIC and 1-MI were dissolved in MEK at 80° C. The solution was held at 80° C. for 60 minutes. Then the PPE-2OH 0.09 was added and dissolved. MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

For Comparative Example 14, the NADIC, DGEBPA, and 1-MI were dissolved in MEK. Then the MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

For Examples 4-6, the PPE-2OH 0.09 was pre-reacted with NADIC before DGEBPA was added and the resulting mixture cured. The PPE 2OH 0.09, NADIC, and 1-MI were dissolved in MEK at 80° C. The solution was held at 80° C. for 60 minutes. Then DGEBPA was added and dissolved. MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

Glass transition temperature values, determined by DSC, are summarized in Table 7. Clearly, inventive examples prepared by a method including pre-reacting the phenylene ether oligomer with the anhydride hardener, exhibited higher T_{g} values than corresponding comparative examples prepared by a method including mixing all components simultaneously, and comparative examples prepared by a method including pre-reacting the phenylene ether oligomer with the epoxy resin. For comparisons at about 10 parts by weight phenylene ether oligomer, see Comparative Example 8 (138.9° C.) versus Comparative Example 11 (139.5° C.) versus Example 4 (144.3° C.). For comparisons at about 20 parts by weight phenylene ether oligomer, see Comparative Example 9 (143.6° C.) versus Comparative Example 12 (144.2° C.) versus Example 5 (152.8° C.). For comparisons at about 30 parts by weight phenylene ether oligomer, see Comparative Example 10 (151.6° C.) versus Comparative Example 13 (150.3° C.) versus Example 6 (165.1° C.).

TABLE 7

| | T_{g} (° C.) |
|---|---|
| C. Ex. 8 | 138.9 |
| C. Ex. 9 | 143.6 |
| C. Ex. 10 | 151.6 |
| C. Ex. 11 | 139.5 |
| C. Ex. 12 | 144.2 |
| C. Ex. 13 | 150.3 |
| C. Ex. 14 | 136.3 |
| Ex. 4 | 144.3 |
| Ex. 5 | 152.8 |
| Ex. 6 | 165.1 |

### Examples 7 and 8, Comparative Examples 15 and 16

These examples illustrate the use of higher and lower molecular weight phenylene ether oligomers. All examples contain about 20 parts by weight phenylene ether oligomer, and about 10-12% excess epoxy equivalents. Formulations are summarized in Table 8, where component amounts are expressed in units of parts by weight per 100 parts resin, where “resin” is defined as the sum of epoxy, anhydride hardener, and phenylene ether oligomer.

TABLE 8

| | PPE-2OH 0.06 | PPE-2OH 0.12 | DGEBPA | NADIC | 1-MI |
|---|---|---|---|---|---|
| C. Ex. 15 | 20.08 | 0.00 | 58.00 | 21.92 | 0.16 |
| C. Ex. 16 | 0.00 | 19.91 | 57.49 | 22.61 | 0.16 |
| Ex. 7 | 20.08 | 0.00 | 58.00 | 21.92 | 0.16 |
| Ex. 8 | 0.00 | 19.91 | 57.49 | 22.61 | 0.16 |

For Comparative Examples 15 and 16, the PPE-2OH 0.06 or PPE-2OH 0.12, DGEBPA, NADIC, and 1-MI were mixing in MEK at 80° C. The MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

For Examples 7 and 8, the PPE-2OH 0.06 or PPE-2OH 0.12 was pre-reacted with NADIC before DGEBPA was added and the resulting mixture cured. The PPE-2OH 0.06 or PPE-2OH 0.12, NADIC, and 1-MI were added to MEK at 80° C. The solution was held at 80° C. for 60 minutes. Then DGEBPA was added and dissolved. MEK was removed from the homogeneous solution. The resin was transferred to a mold which was preheated to 100° C. The filled mold was placed in an oven set at 100° C. and the cure temperature was programmed up to 220° C. as follows:
after 60 minutes at 100° C., the temperature was increase to 120° C.;
after 60 minutes at 120° C., the temperature was increase to 140° C.;
after 60 minutes at 140° C., the temperature was increase to 150° C.;
after 60 minutes at 150° C., the temperature was increase to 160° C.;
after 60 minutes at 160° C., the temperature was increase to 175° C.;
after 60 minutes at 175° C., the temperature was increase to 200° C.;
after 60 minutes at 200° C., the temperature was increase to 220° C.;
the temperature was held at 220° C. for 60 minutes.

Glass transition temperature values, determined by DSC, are summarized in Table 9. Clearly, pre-reacting the phenylene ether oligomer with the anhydride hardener produced significantly higher glass transition temperature values, whether the phenylene ether oligomer had an intrinsic viscosity of 0.06 deciliter per gram (141.4° C. for Comparative Example 15 versus 151.7° C. for Example 7) or 0.12 deciliter per gram (145.2° C. for Comparative Example 16 versus 156.8° C. for Example 8).

TABLE 9

| | T_{g} (° C.) |
|---|---|
| C. Ex. 15 | 141.4 |
| C. Ex. 16 | 145.2 |
| Ex. 7 | 151.7 |
| Ex. 8 | 156.8 |

### Examples 9 and 10, Comparative Examples 17 and 18

The addition of phenylene ether oligomer adds to the complexity of the epoxy curing mechanism. The reaction of the phenolic end groups on phenylene ether oligomer introduces two additional reaction pathways-etherification via reaction of phenolic and epoxy groups, and esterification via reaction of phenolic and anhydride groups. The relative rates of these reactions were determined by ¹H NMR. The reactions were studied by looking at the relative rates for two components at a time. The reactants are PPE-2OH, HHPA, and DGEBPA. DMAP was used as a catalyst. The reaction between PPE-2OH and HHPA used anisole as a solvent. The formulations and type of reaction are summarized in Table 10, where amounts of all components except anisole are expressed in units of parts by weight per 100 parts resin, where “resin” is defined as the sum of epoxy, anhydride hardener, and phenylene ether oligomer. Amounts of anisole are expressed in units of milliliters.

TABLE 10

| | PPE-2OH | | | | | Type of |
|---|---|---|---|---|---|---|
| | 0.09 | DGEBPA | HHPA | Anisole | DMAP | reaction |
| C. Ex. 17 | 20.00 | 80.00 | 0.00 | 0.00 | 0.20 | Etherification |
| C. Ex. 18 | 0.00 | 74.10 | 25.90 | 0.00 | 0.19 | Esterification |
| Ex. 9 | 66.67 | 0.00 | 33.33 | 100.00 | 0.17 | Esterification |

For the Comparative Example 17 reaction of phenylene ether oligomer with epoxy, the reaction was measured by dissolving the phenylene ether oligomer in the epoxy resin at 80° C., and then adding DMAP.

For the Comparative Example 8 reaction of epoxy resin with anhydride hardener, the reaction was measured by mixing the epoxy resin and anhydride hardener, heating to 80° C., and then adding DMAP.

For the Example 9 reaction of phenylene ether oligomer with anhydride hardener, the reaction was measured by dissolving the phenylene ether oligomer in anisole at 80° C., adding anhydride hardener, and then adding DMAP. A solvent, anisole, was used because of the high concentration of phenylene ether oligomer.

For each reaction, samples were removed as a function of time and analyzed with ¹H NMR. Extent of reaction versus time for the three reactions is plotted in FIG. 4. The rate data reveal that under the conditions of this study, each of the reactions is fairly rapid at 80° C., and there are no major differences the rate. This suggests that when phenylene ether oligomer, epoxy resin, and anhydride hardener are mixed together and cured, they would be incorporated into the thermoset matrix almost randomly.

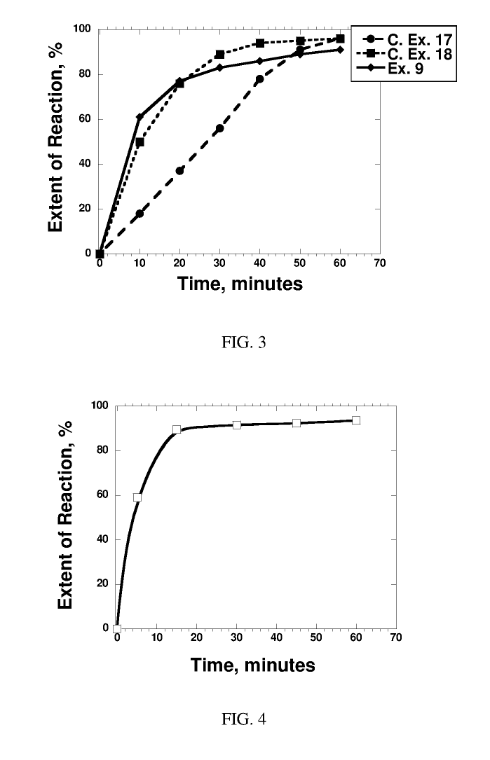

Example 10 illustrates the rate of reaction rate between phenylene ether oligomer and anhydride hardener without a solvent. The formulations and type of reaction are in Table 11. The anhydride hardener was heated to 80° C. and the phenylene ether oligomer was added and dissolved. When the phenylene ether oligomer was completely dissolved, the DMAP was added. Samples were taken with time and analyzed by ¹H NMR. Extent of reaction is plotted against time in FIG. 3. The rate data reveal that under the conditions of this study the phenylene ether oligomer reacts rapidly with the anhydride.

TABLE 11

| | PPE-2OH | | | Type of |
|---|---|---|---|---|
| | 0.09 | HHPA | DMAP | reaction |
| Ex. 10 | 20.00 | 80.00 | 0.20 | Etherification |

1. A method of forming a cured epoxy material, the method comprising:
reacting a phenylene ether oligomer with an anhydride hardener to form a first product;
adding an epoxy resin to the first product to form a second product; and
curing the second product to form a cured epoxy material.

2. The method of claim 1, wherein said reacting a phenylene ether oligomer with an anhydride hardener is conducted at a temperature of 50 to 160° C.

3. The method of claim 2, wherein said reacting a phenylene ether oligomer with an anhydride hardener is conducted in the presence of a solvent selected from the group consisting of C₃-C₈ ketones, C₆-C₈ ethers, C₃-C₆ N,N-dialkylamides, C₆-C₁₀ aromatic hydrocarbons, C₁-C₃ chlorinated hydrocarbons, C₃-C₆ alkyl alkanoates, C₂-C₆ alkyl cyanides, C₂-C₄ dialkyl sulfoxides, and combinations thereof.

4. The method of claim 1, wherein the first product is a homogeneous solution in which at least 75 mole percent of phenolic hydroxyl groups on the phenylene ether oligomer have reacted with the anhydride hardener.

5. The method of claim 1, wherein said adding an epoxy resin to the first product is conducted at a temperature of 60 to 120° C.

6. The method of claim 1, wherein the second product is a homogeneous solution in which at least 75 mole percent of phenolic hydroxyl groups on the phenylene ether oligomer have reacted with the anhydride hardener.

7. The method of claim 1, wherein said curing the second product is conducted at a maximum temperature of 170 to 220° C.

8. The method of claim 1, wherein the phenylene ether oligomer is used in an amount of 5 to 40 parts by weight, the anhydride hardener in an amount of 20 to 40 parts by weight, and the epoxy resin in an amount of 35 to 65 parts by weight, all based on 100 parts by weight total of the phenylene ether oligomer, the anhydride hardener, and the epoxy resin.

9. The method of claim 1, wherein the phenylene ether oligomer has an intrinsic viscosity of 0.03 to 0.2 deciliter per gram, measured at 25° C. in chloroform.

10. The method of claim 1, wherein the phenylene ether oligomer has, on average, 1.5 to 3 hydroxyl groups per molecule.

11. The method of claim 1, wherein the anhydride hardener comprises a monoanhydride having a molecular weight of 98 to 400 grams per mole.

12. The method of claim 1, wherein the anhydride hardener is selected from the group consisting of maleic anhydride, succinic anhydride, dodecenylsuccinic anhydride, cyclohexane-1,2-dicarboxylic anhydride, cis-4-cyclohexene-1,2-dicarboxylic acid anhydride, 4-methyl-4-cyclohexene-1,2-dicarboxylic acid anhydride, phthalic anhydride, hexahydro-o-phthalic anhydride, tetrahydrophthalic anhydride, methyltetrahydrophthalic anhydride, trimellitic anhydride, benzophenone tetracarboxylic acid dianhydride, ethylene glycol bis(trimellitate anhydride), glycerol tris(trimellitate anhydride), 5-norbornene-2,3-dicarbxylic anhydride, methyl-5-norbornene-2,3-dicarbxylic anhydride, and combinations thereof.

13. The method of claim 1, wherein the epoxy resin has an average epoxy functionality of 1.5 to 10 epoxy groups per molecule, and an epoxy equivalent weight of 90 to 500 grams per equivalent.

14. The method of claim 1, wherein the epoxy resin is selected from the group consisting of N-glycidyl phthalimide, N-glycidyl tetrahydrophthalimide, phenyl glycidyl ether, p-butylphenyl glycidyl ether, styrene oxide, neohexene oxide, ethylene glycol diglycidyl ether, polyethylene glycol diglycidyl ether, propylene glycol diglycidyl ether, polypropylene glycol diglycidyl ether, tetramethyleneglycol diglycidyl ether, polytetramethylene glycol diglycidyl ether, adipic acid diglycidyl ester, sebacic acid diglycidyl ester, phthalic acid diglycidyl ester, bisphenol A diglycidyl ether, bisphenol F diglycidyl ether, bisphenol S diglycidyl ether, resorcinol diglycidyl ether, tetraglycidyldiaminodiphenylmethane, oligomers of the foregoing compounds, glycidyl ethers of phenol-formaldehyde novolac, glycidyl ethers of cresol-formaldehyde novolac, glycidyl ethers of t-butylphenol-formaldehyde novolac, glycidyl ethers of sec-butylphenol-formaldehyde novolac, glycidyl ethers of tert-octylphenol-formaldehyde novolac, glycidyl ethers of cumylphenol-formaldehyde novolac, glycidyl ethers of decylphenol-formaldehyde novolac, glycidyl ethers of bromophenol-formaldehyde novolac, glycidyl ethers of chlorophenol-formaldehyde novolac, glycidyl ethers of phenol-bis(hydroxymethyl)benzene novolac, glycidyl ethers of phenol-bis(hydroxymethylbiphenyl) novolac, glycidyl ethers of phenol-hydroxybenzaldehyde novolac, glycidyl ethers of phenol-dicyclopentadiene novolac, glycidyl ethers of naphthol-formaldehyde novolac, glycidyl ethers of naphthol-bis(hydroxymethyl)benzene novolac, glycidyl ethers of naphthol-bis(hydroxymethylbiphenyl) novolac, glycidyl ethers of naphthol-hydroxybenzaldehyde novolac, glycidyl ethers of naphthol-dicyclopentadiene novolac, triglycidyl ether of p-aminophenol, glycidyl ethers of cresol-formaldehyde novolac, BPA novolac epoxy, diglycidylether of 1,4 butane diol, epoxidized soybean oil, epoxidized castor oil, diglycidyl ether of neopentyl glycol, 2-ethylhexyl glycidyl ether, butyl glycidyl ether, phenyl glycidyl ether, t-butyl glycidyl ether, o-cresyl glycidyl ether, nonyl phenol glycidyl ether, cyclohexane dimethanol diglycidyl ether, trimethylol ethane triglycidyl ether, trimethylol propane triglycidyl ether, tetra glycidyl ether of meta-xylenediamine, tetraglycidyl ether of tetraphenolethane, dicyclopentadiene dioxide, 3,4-epoxy-cyclohexyl-methyl-3,4-epoxy-cyclohexyl carboxylate, diglycidyl ether of d-hydroxy naphthalene, and combinations thereof.

15. The method of claim 1, wherein the cured epoxy material exhibits
a glass transition temperature of 150 to 250° C. measured by differential scanning calorimetry, and
an unnotched Izod impact strength of 80 to 200 joules/meter at 23° C. determined according to ASTM D 4812-11 at 23° C.

16. The method of claim 1,
wherein said reacting a phenylene ether oligomer with an anhydride hardener is conducted at a temperature of 60 to 120° C.;
wherein the phenylene ether oligomer has an intrinsic viscosity of 0.03 to 0.2 deciliter per gram, measured at 25° C. in chloroform, and, on average, 1.5 to 2.5 hydroxyl groups per molecule;
wherein the anhydride hardener comprises a monoanhydride having a molecular weight of 98 to 200 grams per mole;
wherein said reacting a phenylene ether oligomer with an anhydride hardener is conducted in the presence of a solvent; and wherein the method further comprises removing solvent from the first product, the second product, or both;
wherein the phenylene ether oligomer is used in an amount of 5 to 40 parts by weight, the anhydride hardener in an amount of 20 to 40 parts by weight, and the epoxy resin in an amount of 35 to 65 parts by weight, all based on 100 parts by weight total of the phenylene ether oligomer, the anhydride hardener, and the epoxy resin;
wherein said curing the second product is conducted at a maximum temperature of 180 to 250° C.; and
wherein the cured epoxy material exhibits a glass transition temperature of 150 to 250° C. measured by differential scanning calorimetry, and an unnotched Izod impact strength of 80 to 200 joules/meter at 23° C. determined according to ASTM D 4812-11 at 23° C.

17. A cured epoxy material formed by the method of claim 1 and exhibiting
a glass transition temperature of 150 to 250° C. measured by differential scanning calorimetry, and
an unnotched Izod impact strength of 80 to 200 joules/meter at 23° C. determined according to ASTM D 4812-11 at 23° C.

18. A product of reacting a phenylene ether oligomer with a monoanhydride, wherein the phenylene ether oligomer has, on average, 1.5 to 3 hydroxyl groups per molecule, wherein the phenylene ether oligomer and the monoanhydride are reacted in amounts effective to provide an initial molar ratio of hydroxyl groups to anhydride groups of 0.04:1 to 0.26:1, and wherein in the product at least 75 mole percent of hydroxyl groups on the phenylene ether oligomer have reacted with the monoanhydride.

19. A composite core for an aluminum conductor composite core reinforced cable, the composite core comprising:
two or more types of longitudinally oriented and substantially continuous reinforcing fibers selected from the group consisting of carbon fibers, basalt fibers, glass fibers, ceramic fibers, aramid fibers, boron fibers, liquid crystal fibers, and polyethylene fibers; and
a cured epoxy material surrounding the reinforcing fibers, wherein the cured epoxy material is the product of reacting components comprising a phenylene ether oligomer, an epoxy resin, and a curing promoter;
wherein said composite core has at least 50 volume percent fiber.

20. The composite core of claim 19,
wherein the curing promoter comprises an anhydride hardener, and wherein the reacting the phenylene ether oligomer, the epoxy resin, and the curing promoter comprises reacting the phenylene ether oligomer with the anhydride hardener to form a first product; adding the epoxy resin and the fibers to the first product to form a second product; and curing the second product to form cured epoxy material surrounding the fibers; or
wherein the reacting the phenylene ether oligomer, the epoxy resin, and the curing promoter comprises reacting the phenylene ether oligomer with the epoxy resin to form a first product; adding the curing promoter and the fibers to the first product to form a second product; and curing the second product to form cured epoxy material surrounding the fibers.
